(19) United States
(12) Patent Application Publication
(10) Pub. No.: US 2024/0205703 A1
(43) Pub. Date: Jun. 20, 2024

(54) INTERFERENCE-AWARE WIRELESS COMMUNICATION LINK ADAPTATION

(71) Applicant: Amazon Technologies, Inc., Seattle, WA (US)

(72) Inventors: Muhammed Faruk Gencel, Poway, CA (US); Basak Oyman, Mountain View, CA (US); Ravi Ichapurapu, Morgan Hill, CA (US)

(21) Appl. No.: 18/081,159

(22) Filed: Dec. 14, 2022

(51) Int. Cl. H04W 24/08; H04L 1/00; H04L 43/0823

(52) U.S. Cl. CPC H04W 24/08; H04L 1/0003; H04L 43/0847

(57) ABSTRACT

In various examples, systems and methods of wireless communication link adaptation are described. In some examples, first data may be determined for a first gateway device, the first data representing a plurality of received signal strength (RSS) values of a first signal received from a first end node device. Second data representing an interference associated with the first signal may be determined. At least one of a first packet error rate or a first packet success rate may be determined based at least in part on the first data and the second data. A first modulation coding scheme (MCS) associated with at least one of the first packet error rate or the first packet success rate may be determined. Third data may be sent to the first end node, the third data instructing the first end node device to use the first MCS for communication with the first gateway device.

### BACKGROUND

Link adaptation typically refers to adaptive coding and modulation to match various signal and protocol parameters to the prevailing conditions on a wireless communication link. These techniques can be important for network performance particularly in environments with high and/or rapidly-changing noise levels.

### BRIEF DESCRIPTION OF DRAWINGS

FIG. 1A is a block diagram illustrating an example of interference-aware wireless communication link adaptation, according to various aspects of the present disclosure.

FIG. 1B is a state diagram for packet error rate estimation in the presence of interference by a wireless receiver device, in accordance with various aspects of the present disclosure.

FIG. 2 is a block diagram of an example of gateway device selection for communication with an end node device, in accordance with various aspects of the present disclosure.

FIG. 3 is an example lookup table that may be used to determine a modulation coding scheme for a gateway device that is experiencing interference, in accordance with various aspects of the present disclosure.

FIG. 4 is a state diagram for uplink rate adaptation based on interference prediction modeling, in accordance with various aspects of the present disclosure.

FIG. 5 is an example computing device architecture that may be used in accordance with various techniques described herein.

FIG. 6 is a diagram illustrating an example system for sending and providing data that may be used in accordance with the present disclosure.

FIG. 7 depicts a packet error rate vs. signal-to-noise ratio curve for a typical environment with stationary gateway and end node devices, in accordance with various aspects of the present disclosure.

### DETAILED DESCRIPTION

In the following description, reference is made to the accompanying drawings that illustrate several example embodiments of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Three Key Performance indicators (KPIs) that can be useful in predicting a packet success rate (PSR) (e.g., the rate at which transmitted packets are successfully received by a receiver device) in a wireless communication medium are Received Signal Strength (RSS), Carrier-to-Interference ratio (C/I), and Signal to Noise ratio (SNR). RSS may be expressed in units of decibels per milliwatt (dBm), whereas SNR and C/I metrics are relative numbers that may be expressed in the decibel (dB) scale. The RSS depends on the wireless channel and can in some instances be characterized as representing a desired signal's power as detected by the receiver.

For example, a received signal strength indicator (RSSI) value may be determined based on a voltage level from a baseband signal chain before a baseband amplifier. Output from an RSS circuit may be an analog direct current voltage level. This output can be sampled by an analog-to-digital converter (ADC) to determine RSSI values for a given time. A voltage value (in volts) sampled by an ADC may be converted to a power value for a given impedance Z, e.g. P=V*V/Z. However, in order to convert this into an RSSI value, it is generally desirable to have this power value expressed in decibels per milliwatt, e.g. P(dbm)=10*Log 10(1000*P). Accordingly, a voltage value (in volts) sampled by an ADC may be converted to an RSSI value (in decibels per milliwatt) using, e.g., a formula such as P(dbm)=10*Log 10(1000*V\hat{ }2/Z).

In systems involving end node devices or client devices that communicate with a gateway device that in turn is in communication with a remote computing system or cloud, communications from the end node device or client device to the gateway device and onward to the cloud can be characterized as uplink communications, while communications in the opposite direction from the cloud to the gateway device and onward to the end node device or client device can be characterized as downlink communications.

RSS can be estimated to be the same for both uplink (UL) (e.g., transmission link from an end node or client device to a gateway device) and downlink (DL) (e.g., transmission link from a gateway device to an end node or client device) links due to channel reciprocity, as long as the time elapsed in between the use of the links is within the coherence time of the channel. In such a case, the RSS determined in the UL can be used to determine the best gateway device (GW) to serve for the DL direction. For example, if a transmitted message from an end node device is received at two gateway devices, the gateway devices may both forward the message on to a remote computing system, together with an indication of a respective RSS value associated with the received message. The remote computing system may compare the respective RSS values received from the gateway devices to determine which gateway device to utilize for a downlink communication destined for the end node device.

RSS may depend on terrain type, distance to a given gateway device, channel frequency, antenna gains, and antenna directivity. Carrier-to-Interference ratio (C/I), however, mainly depends on the environment in which the receiving device resides at a given time. The term C/I refers to a ratio of the RSS to co-channel interference experienced within the desired signal bandwidth. In many cases, it is difficult to predict C/I because the interference can be sporadic and bursty during reception of a given packet, depending on a series of events that are triggered in the environment. Furthermore, unlike RSS channel reciprocity, the C/I observed at the end node device (EN) in the DL direction is not the same as the C/I observed at the gateway device in the UL direction. This is because the GW and EN are typically separated by a large distance on the order of hundreds of meters and typically reside at different environments, with different interfering sources around them. Accordingly, it may be advantageous to estimate the interference observed in the UL as well as DL separately. An estimate of interference may be referred to as an estimated interference level in some examples used herein.

The third metric, SNR, can be characterized as a desired signal's RSS relative to thermal noise of the receiving device as integrated by the signal bandwidth. Both the RSS and SNR can be predicted at the receiver (RX) device without the need for explicit feedback from the transmitter (TX). The RSS and SNR typically vary at a much slower rate than C/I. Generally, the higher a desired signal's RSS, SNR, and C/I, the better the Packet Success Rate (PSR) will be (and conversely, the lower the Packet Error Rate (PER) will be). In order to estimate the PSR of the communication link, it may be useful to consider RSS, C/I, and SNR.

The PSR may be defined as PSR=1−PER, where PER represents Packet Error Rate. An estimate of PSR can be determined as a function of the desired signal's RSS, C/I, and SNR, which can each be characterized as a function of, or being impacted by, distance d, time 1, and frequency f. Two geographically different receivers located at the same distance to a transmitter generally will not result in the same RSS and C/I experienced by the receivers due to changes in the geography and interference levels associated with each receiver. Hence, the RSS and C/I parameters should be monitored by the receiver. In the case of an uplink transmission, a gateway device may be the receiver, while an end node may be the receiver for a downlink transmission. Having an RSS larger than a device's sensitivity does not guarantee packet success as the device might be experiencing severe interference at a given time. The PSR also depends on the robustness of the chosen Modulation and Coding Scheme (MCS), which can be characterized as a transmission scheme. Different MCSs provide different bitrates and different level of resilience to impairments such as interference. To try to help estimate packet success at a receiver with a given MCS, two conditions may be helpful to consider:

$$R S S ( t , d , f ) > Sensitivity , \qquad 1.$$

$$C / I ( t , d , f ) > C / {I}_{t h reshold} , \qquad 2.$$

which are two independent random variables. The term C/I_{threshold} represents the carrier to interference ratio threshold that can be tolerated without performance degradation, in dB. These conditions depend on the selected MCS. If both conditions are met, it can be estimated that there is a good chance of successful wireless packet receipt.

Described herein are various systems and techniques that may be used to estimate the PSR (and/or PER) per MCS in the presence of interference. In various examples, the PSR (and/or PER) per MCS in the presence of interference may be determined for each gateway device based on signals received from end nodes. The various systems and techniques described herein may consider metrics such as RSS and SNR, but may also consider an interference level experienced by the receiver (e.g., a particular gateway device) over a period of time. This may allow for a more realistic estimated PSR value (relative to traditional techniques that consider only RSS and/or SNR).

A PSR may be predicted by a cloud service (e.g. based on data received from a gateway device) or a gateway device.

The PSR may be predicted across available MCSs and gateway devices by, and/or may be reported to, a cloud-based link adaptation service for decision making. The cloud-based link adaptation service may select the best gateway device and best MCS for communication with a given end node. The selected MCS may be selected to maximize PSR and/or reduce end node power consumption. It should be noted that PSR and PER may be used interchangeably herein as either metric may be used with the correspondence generally being defined as PER=1−PSR.

In accordance with one or more preferred implementations, PER is minimized via MCS selection, and/or an MCS is selected to minimize power consumption at the ENs.

Systems and techniques described herein may determine interference that each GW experiences at various times, and then use interference data to predict interference that a GW experiences. Interference data comprising determined interference values may be computed by each GW and sent to the cloud for centralized decision making across GWs. For each MCS and GW, PSR may be estimated as a function of interference and RSS (and/or SNR). Further, an optimized MCS may be determined per GW or per end node device that not only improves PSR but also reduces power consumption. In addition, various systems and techniques described herein offer a compact design of control information that needs to be sent from the cloud to the gateway devices and to each end node device.

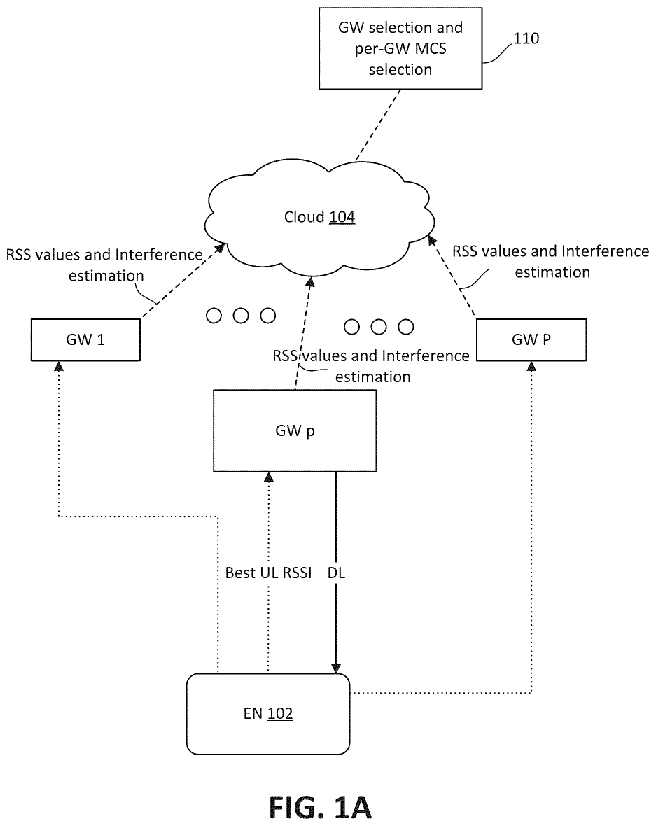

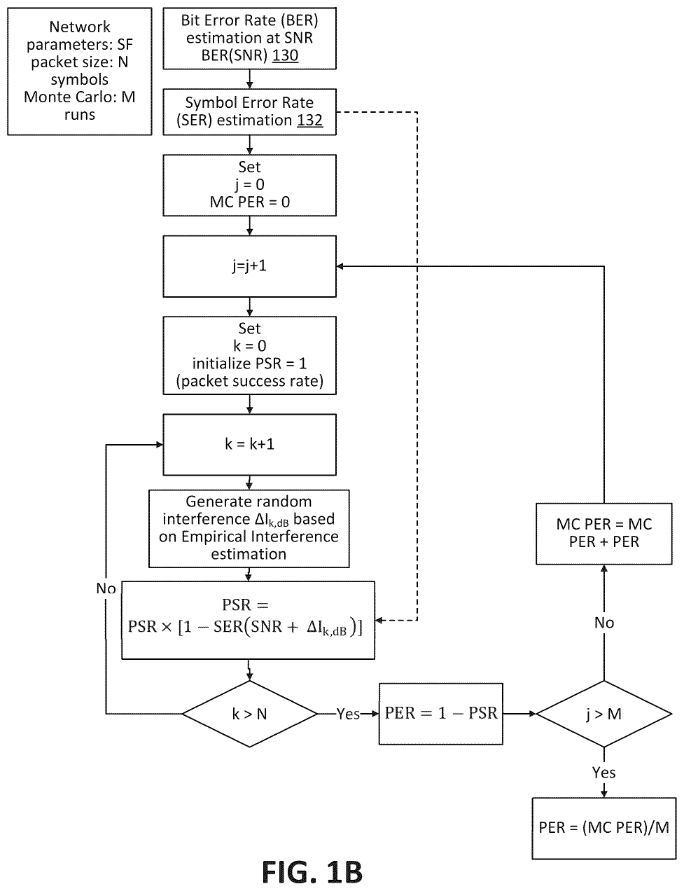

FIG. 1A is a block diagram illustrating an example of interference-aware wireless communication link adaptation, according to various aspects of the present disclosure. In various examples, cloud 104 may comprise a plurality of networked computing devices (which may include physical and/or virtualized computing devices) which may include at least one remote computing device with respect to end nodes devices and/or gateway devices. The cloud 104 may provide any desired compute services to end node devices such as EN 102. In some examples, one or more quality of service (QOS) requirements (e.g., quality of service levels) may be associated with network communication for a given compute service. Although only a single end node device (EN 102) is shown in FIG. 1A, any number of end node devices may be configured in wireless communication with cloud 104.

End node devices, including EN 102, may communicate with cloud 104 via one or more gateway devices (including GW 1, p, and P, where p□{1, 2, . . . , P}). As described in further detail below, each gateway device may estimate or determine interference and RSS experienced by that gateway device (e.g., periodically, continually, and/or semi-periodically). This information may be sent to the cloud 104. In some other examples, each gateway device may send various information (described in further detail below in reference to FIG. 1B) to the cloud 104 and the cloud 104 may determine or estimate interference experienced by each gateway device. The cloud 104 may select the best gateway from among all available gateway devices for communication with a given end node (e.g., EN 102) (e.g., based on the uplink RSSI). In addition, the cloud 104 may determine the best MCS to use based on the best PER estimate for available MCSs for the RSS (and/or SNR value) and interference level reported by (or determined for) the particular gateway device (block 110). In addition, the cloud may select the MCS that satisfies any relevant quality of service (QOS) requirements, while minimizing power consumption at the end node, as described in further detail below. In general, the cloud 104 may generate a lookup table for each gateway device that specifies PSR (or PER) for different MCSs for a given SNR (and/or RSS) value, where the PSR/PER estimates are based on SNR (and/or RSS) values and interference levels determined or estimated for the gateway device. The lookup table may also indicate an estimate of power consumption for each MCS index, which may be calculated based on, or affected by, a spreading factor (SF) and/or a packet repetition value (e.g., the number of duplicate transmissions per packet or per symbol). The spreading factor may refer to the speed at which the signal frequency changes across the bandwidth of a channel. The spreading factor controls the chirp rate (e.g., the symbol rate) and thus controls the speed of data transmission. Lower spreading factors result in faster chirps and therefore higher data transmission rates. Lower spreading factors reduce the range of LoRa transmissions, because they reduce the processing gain and increase the bit rate. The spreading factor and/or the packet repetition value may be adjusted, as described below in order to meet a desired QoS. The MCS associated with the least amount of power consumption that meets QoS requirements may be selected and the cloud 104 may send the index value representing the selected MCS to the gateway device. The gateway device, in turn, may send the instructions to EN 102 to use the selected MCS for uplink communication.

FIG. 1B is a state diagram for packet error rate estimation in the presence of interference by a wireless receiver device, in accordance with various aspects of the present disclosure. RSSI and interference levels may be predicted and monitored continuously (or at a desired cadence) by each GW and may not require explicit feedback from ENs. The various wireless communication described herein may operate on the unlicensed ISM band, or any other desired band. There may be various interference sources within the area where each GW resides. Generally, each GW continuously monitors/sniffs the interference level to generate statistics of the interference in the ISM band (or other band) with respect to the thermal noise.

In accordance with one or more preferred implementations, in order to periodically sample interference, a GW monitors the RSSI at a desired band with a granular duration of Tₛ seconds. This granularity is less than a packet duration and hence statistics are generated over several symbols and packets over a period of T seconds.

Such estimation captures not only the sporadic and bursty interference, but also the ambient noise floor increase, which may be due to a variety of reasons such as temperature change and intermittent radio frequency impairments. The various techniques described herein are readily scalable to any number of gateway devices and/or end nodes.

For a given gateway considering a given bandwidth, a thermal noise floor, in dBm, may be calculated as:

$${n}_{t h} = - 1 \; 74 dB m / Hz + 10 {log}_{10} B W + N F , \qquad ( Eq - 0 )$$

where the Noise Figure (NF), in dB, and bandwidth (BW) in Hz, is known at each GW. The desired signal strength (RSS) can be defined as: RSS=SNR+nₜₕ, in dBm, an estimate of which may be denoted by RSSIₜᵣᵤₑ, in dBm per signal bandwidth. With any Spread Spectrum Modulations (such as Lora modulation), the RSSIₜᵣᵤₑ can be estimated even in the presence of interference due to the processing gain provided.

The estimated KPIs such as NF, SNR, etc., have errors depending on chip-to-chip variations, and can be calibrated versus temperature, process, voltage, and/or channel frequency.

The GW's chipset reports the SNR (in dB), and RSSIₜᵣᵤₑ from the packets sent by ENs. As used, herein the chipset refers to the set of one or more integrated circuits and/or electronic components that form the set of such circuits/components enabling the GW to function. The RSSI is measured by the chipset in time domain, and if a co-channel interferer is present, RSSI contains not only the power of the RSS but also an interference power I(t).

The GW can estimate the interference and other noise sources by continuously monitoring the RSSI and derive interference power as:

$$I ( t ) = 10 \times {log}_{10} \{ {10}^{R SSI / 10} - 1 {0}^{( \frac{{n}_{t h}}{10} )} \} , dB m > {n}_{t h} \qquad ( Eq - 1 )$$

When there is no interference, RSSIₜᵣᵤₑ and SNR are linearly correlated. SNR and RSSIₜᵣᵤₑ can be used interchangeably due to the linear correlation over thermal noise floor. The interference statistics are estimated and then used to estimate PER (as shown in FIG. 1B).

The estimate of the SNR and SINR are related to each other as follows:

$${SNR}_{estimate} = {RSSI}_{true} - {n}_{th} , dB , \qquad ( Eq - 2 )$$

where RSSIₜᵣᵤₑ represents the estimate of the RSS. Then the estimate of the SINR can be defined as:

$${SINR}_{estimate} = {RSSI}_{t r u e} - 10 \times {log}_{10} \{ {10}^{\frac{I ( t )}{10}} + 1 {0}^{\frac{{n}_{t h}}{10}} \} , dB , \qquad ( Eq - 3 )$$

where SINR is the ratio of the desired signal power to the sum of the undesired noise sources such as thermal noise and interference.

Putting Eq-2 into Eq-3, Eq-4 can be obtained:

$${SINR}_{estimate} = S N {R}_{estimate} + {n}_{t h} - 10 \times {log}_{10} \{ {10}^{\frac{I ( t )}{10}} + 1 {0}^{\frac{{n}_{t h}}{10}} \} , dB , \qquad ( Eq - 4 )$$

When I(t)>>n(t), i.e., when the interference is dominating the receiver performance, Eq-4 approaches to:

$${SINR}_{estimate} \approx {SNR}_{estimate} + {n}_{th} - I ( t ) , dB , \qquad ( Eq - 5 )$$

In the following, ΔI_{i,dB}=nₜₕ−I(t), dB is defined, which is the difference of the thermal noise floor (in dBm) and the interference level (in dBm). Equation 5 is valid only when ΔI_{i,dB}>>10 dB, i.e., the approximation error becomes negligible. Otherwise, Equation-1 and 4 may be used for each iteration (as described below) to compute the SINRₑₛₜᵢₘₐₜₑ without approximation errors.

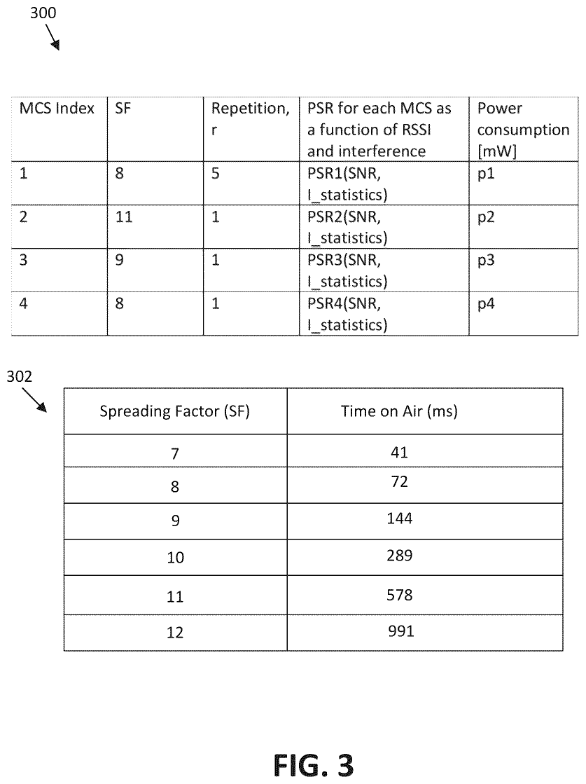

An example method to estimate the PER (or PSR) in the presence of interference is illustrated in FIG. 1B. The Packet Error Rate (PER) is estimated based on statistics from empirical interference prediction modeling. A look-up table (LUT) is created and saved into the cloud 104 for link adaptation decision making. A fanciful illustration of data in an exemplary LUT is depicted in FIG. 3. In accordance with one or more preferred implementations, a lookup table allows for lookup of calculated PER (or PSR) values for a given SNR (or RSS) value and a given modulation and coding scheme (MCS). A lookup table may also provide power consumption data for the MCS (e.g. power consumption data associated with a given SNR (or RSS) value and a given MCS).

In accordance with one or more preferred implementations, a LUT is generated based on Monte Carlo simulations of M instances of interference distribution. A packet may include N symbols. With the example of Lora modulation, each symbol includes SF bits. The Bit Error Rate (BER) is theoretically calculated from the known approximation as:

BER(SNR)=0.5*Q(\sqrt{SNR*2^{SF+1}}−\sqrt{1.386*SF+1.154}), under Additive White Gaussian Noise (AWGN) conditions.

This corresponds to block 130 in the state diagram in FIG. 1B. Then, Symbol Error Rate (SER) is calculated as:

$$SER ( SNR ) = \frac{{2}^{S F} - 1}{{2}^{S F - 1}} * B E R ( S NR ) . \qquad ( block 132 )$$

Let Iᵢ be interference at the ith symbol. Shifting the AWGN noise floor by ΔIᵢ may be a good approximation to model the interference at a particular symbol. Then, the SER may be shifted to SER(SNR+ΔIᵢ, dB) for that particular symbol under AWGN noise and interference effect.

PER may be estimated in the presence of interference without error correcting codes as follows:

$$P E R = 1 - {\prod }_{i = 1}^{N} ( 1 - S E R ( S N R + Δ {I}_{i , dB} ) ) ,$$

where probability of error is equivalent to 1 minus not having any error on all the N symbols that went through interference Iᵢ. Also, if it is assumed that there are r repetitions for a packet with same SF, the PER estimation becomes

$${P E R = 1 - {\prod }_{i = 1}^{N} ( 1 - S E R ( S N R + Δ {I}_{i , dB} ) ) )}^{r} ,$$

which indicates that the received packet is erroneous only if all the r repetitions have errors.

Monte Carlo Simulations of M iterations may be used to estimate the average PER as shown in FIG. 1B, such as M=10000. For each symbol, different instances of interference level are generated with parameters that match to the empirical measurements for a suburban (or other) environment. An interference vector with a size of N symbols per packet is generated at each Monte Carlo iteration m∈{1, 2, . . . , M}, and then average PER is estimated across all M iterations where one packet is created per iteration. The state diagram in FIG. 1B shows the proposed algorithm without repetition (r=1). The average PER is eventually determined based on the SF, packet repetitions, number of symbols N (or equivalently packet size/SF), SNR, and interference. The PER is defined as PERₚ(SF, r, N, SNR, I_{statistics}), where PSR=1−PER. The term p represents the gateway index, where p∈{1, 2, . . . , P}.

Once the PSR for a given SNR and modulation and coding scheme is determined based on the aforementioned parameters and simulations, the PSR may be saved in a LUT and stored in the cloud 104. LUTs for each GW may be used for decision making based on time varying parameters across all the GWs. A fanciful depiction of an example LUT 300 is depicted in FIG. 3. The LUT is prepared for a subset of these input parameters and saved into memory (e.g., non-transitory computer-readable memory of cloud 104). If a real-time value of the interference level falls in between two points in the LUT, the actual value may be calculated based on linear interpolation. The LUT 300 includes a column for the power consumption level (e.g., a power consumption estimate) for each MCS. The power consumption estimate may be computed over the packet size (N) and the corresponding airtime needed for UL. During such airtime, the EN is in active transmission state, which determines the transmission power consumption per MCS. Higher bitrate MCSs result in shorter airtimes, hence reducing transmission power consumption. If in the LUT there are multiple MCS candidates that can meet a certain PER QoS target (e.g., a target packet error rate or target packet success rate), then the MCS with the highest bitrate may be selected to save power at the end nodes (which may be power constrained (e.g., battery operated devices). Target packet error rates or target packet success rates (e.g., QoS targets) may be predefined target packet error rates or target packet success rates (e.g., defined for a particular application and/or compute service).

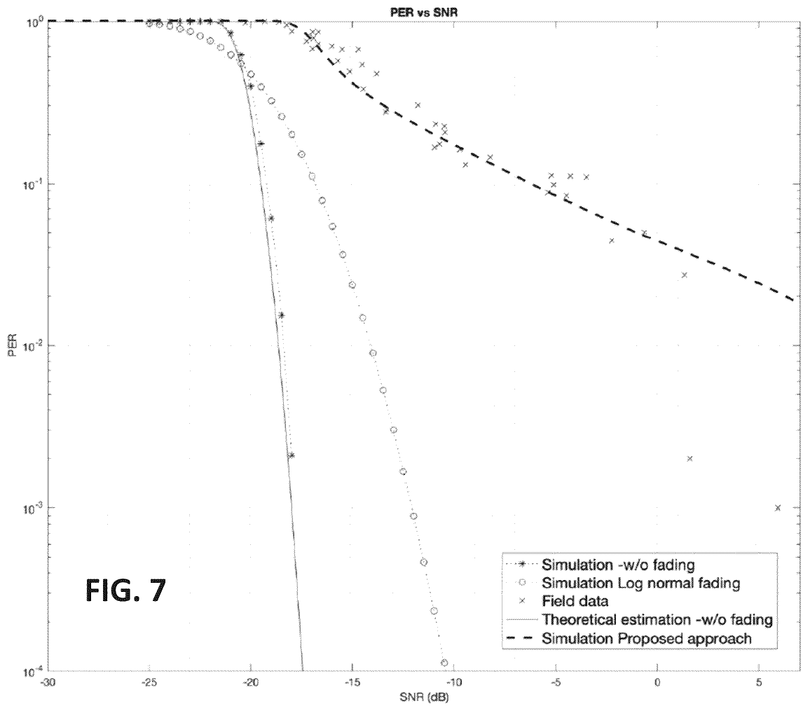

The PER vs SNR curve that corresponds to a typical suburban environment where GW and ENs are stationary is shown in FIG. 7. The channel observed in the field tests are log-normally distributed. The PER estimation without considering interference overestimates the system performance, and decisions without considering ISM band interference could cause QoS issues in the network. The proposed approach using the state diagram in FIG. 1 matches as shown in FIG. 7. The proposed approach is based on learning the interference online and generalizes to urban, suburban, and rural areas.

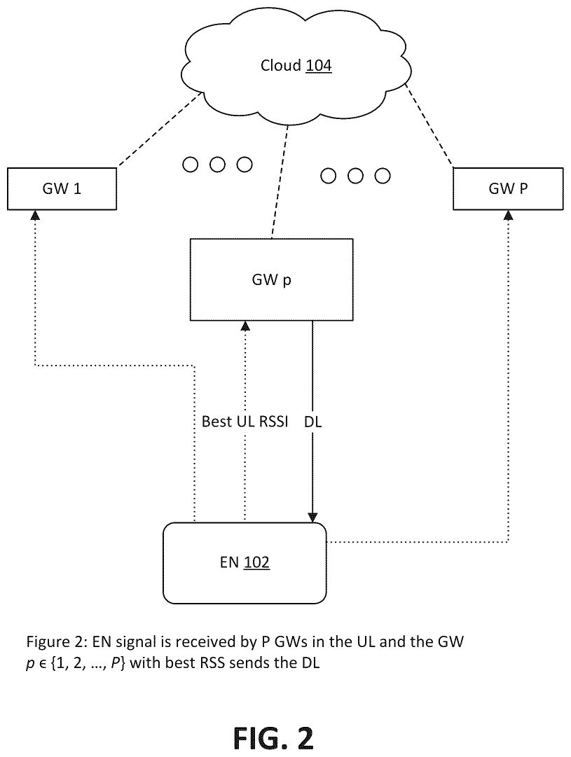

FIG. 2 is a block diagram of an example of gateway device selection for communication with an end node device (EN 102), in accordance with various aspects of the present disclosure. As previously described, there may be P GWs who are in range of an EN 102. All GWs are able to receive UL signals but only the best GW (e.g., GW p), is selected for DL as shown in FIG. 2. The GW p may be selected by cloud 104 to serve to EN u (e.g., EN 102) based on meeting the following condition:

pᵤ=arg{maxₚ{SNR_{p,u}}}, where p∈{1, 2, . . . , P}, u∈{1, 2, . . . , U}. Alternatively, the max RSSI may be used.

Accordingly, the best GW is selected based on the strongest RSS that the GW experiences in the UL direction from a given EN. The cloud 104 makes the assumption that the RSS will remain the same during the DL direction.

FIG. 3 is an example lookup table (LUT) 300 that may be used to determine a modulation coding scheme (MCS) for a gateway device that is experiencing interference, in accordance with various aspects of the present disclosure. Once the PER (or PSR) LUT is prepared for a given gateway, using the approach presented in FIG. 1B and described above, the UL rate adaptation may be determined by the cloud 104 and the MCS index to be used may be sent to the GW. This may be performed for each GW device. The LUT 300 may be prepared daily, weekly, or at any other desired cadence based on interference statistics. After receiving the selected MCS, the serving GW then sends data identifying the selected MCS to use for UL to each end node associated with the GW.

Each GW provides inputs to the cloud 104 on the RSS and interference levels experienced by that GW. Then the cloud 104 determines not only the best GW (e.g., using RSSI and/or SNR as described in reference to FIG. 2), but also the best MCS to be used based on the best PER estimate for available MCSs for a given RSS and interference level. The ENs may be oblivious to the cloud 104 and the goal may be to minimize power consumption at the ENs while meeting Quality of Service (QOS) requirements. An example QoS requirement may be to maintain a PSR>85%. It should be noted that the QoS requirements are typically application dependent.

For example, the cloud 104 may receive the interference and SNR information from a GW p. The cloud 104 may calculate the PSR associated with these statistics as described above and may generate the LUT 300. Later, the cloud 104 may receive current SNR value from the GW p and may use the SNR value to query the lookup table 300 to determine the PSR for the SNR value (which was determined based on the most recent interference data used to generate the LUT 300). The PSR may be associated in the LUT 300 with an MCS index. The MCS may be selected so as to satisfy the relevant QoS requirements (e.g., a PSR or PER requirement). However, if multiple MCSs satisfy the QoS requirement(s), the MCS associated with the lowest power consumption (among MCSs satisfying the QoS requirement) may be used. The selected MCS index value may be sent by the cloud 104 to the relevant GW (e.g., the gateway associated with the particular LUT 300). Only the MCS index needs to be transmitted, which may include as few as 2 bits (in a four MCS index LUT).

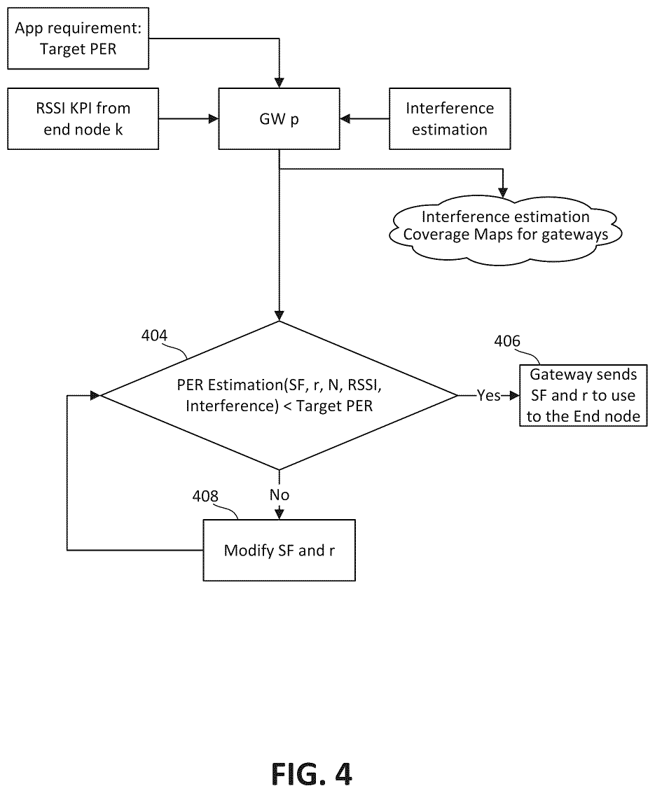

If the QoS requirement in terms of PSR is not met for the selected MCS, the cloud 104 may instruct the GW to instruct the EN 102 to increase SF and repetition r such that the QoS is met (as shown and described in FIG. 4). Alternatively, if QOS is already met (e.g., where the EN 102 is in close range to the GW p), the GW instructs the EN 102 to reduce the SF and packet repetitions, which may provide power saving in the EN 102 while achieving the Qos requirements. To explain this further, PER(SI, r, N, SNR, I_{statistics})<target PER−γ, where γ is the device defined threshold for determining the acceptable PER margin, the cloud may instruct the GW to use a lower SF, which reduces the air time for the packet and conserves power while being within the QoS requirements.

The index in LUT 300 may be used for selection of SF and repetition rate, r, as a function of the RSSI (and/or SNR) and interference (as previously described). Additionally, the GW only needs 2 bits as control information using 4 indexes. The lookup table generalizes for different SF and repetitions per a network's capabilities. Higher bitrate MCSs burn less power on the average due to shorter airtimes. Hence, p4<p3<p2 (where higher SF is associated with longer transmission times, as shown in table 302). Due to packet repetitions, p4<p1 and p1<p2 (since 72 ms*5 repetitions=360 ms (p1)<578 ms (p2)). The example values in table 302 are based on a packet size of 10 bytes at 125 kHz bandwidth.

FIG. 4 is a state diagram for uplink rate adaptation based on interference prediction modeling, in accordance with various aspects of the present disclosure. In the example of FIG. 4, the GW p receives an application QoS (e.g., a target PER, target latency, etc.). Additionally, the GW p determines an RSSI associated with UL communication from EN k. The GW p estimates interference level experienced by the GW p, as described above. The GW p may send the interference estimate and/or the RSSI level to cloud 104 and cloud 104 may determine the PSR based on the interference estimate and RSSI. The cloud 104 may select an MCS using the LUT for the GW p using the PSR to query the LUT. As shown in FIG. 3, the MCS may be associated with a spreading factor SI and a packet repetition value r. At action 404, a determination may be made whether the PER estimate associated with the selected MCS is less than the target PER (e.g., from the QoS). If so, processing may proceed to action 406 and the GW p may send the SI and r values from the LUT to the end node (e.g., EN 102) to use for the UL. Conversely, if the PER estimate is greater than or equal to the target PER, the GW p may modify SI and r (e.g., by increasing the SI and/or the r at action 408) and may return to action 404 until the PER is less than the target PER.

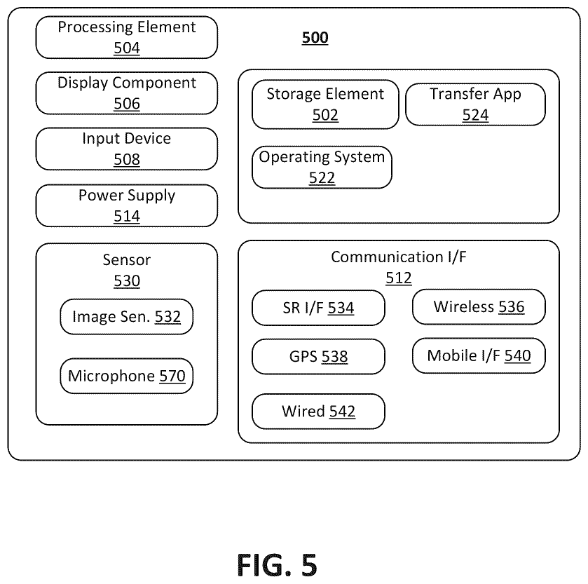

FIG. 5 is a block diagram showing an example architecture 500 of a computing device that may be used in accordance with various aspects of the present disclosure. For example, the architecture may perform one or more of the interference-aware wireless communication link adaptation techniques described above in reference to FIGS. 1-4. In various other examples, one or more components of the architecture 500 may be included in an end node device, such as EN 102. It will be appreciated that not all devices will include all of the components of the architecture 500 and some user devices may include additional components not shown in the architecture 500. The architecture 500 may include one or more processing elements 504 for executing instructions and retrieving data stored in a storage element 502. The processing element 504 may comprise at least one processor. Any suitable processor or processors may be used. For example, the processing element 504 may comprise one or more digital signal processors (DSPs). The storage element 502 can include one or more different types of memory, data storage, or computer-readable storage media devoted to different purposes within the architecture 500. For example, the storage element 502 may comprise flash memory, random-access memory, disk-based storage, etc. Different portions of the storage element 502, for example, may be used for program instructions for execution by the processing element 504, storage of images or other digital works, and/or a removable storage for transferring data to other devices, etc.

The storage element 502 may also store software for execution by the processing element 504. An operating system 522 may provide the user with an interface for operating the computing device and may facilitate communications and commands between applications executing on the architecture 500 and various hardware thereof. A transfer application 524 may be configured to receive images, audio, and/or video from another device (e.g., a mobile device, image capture device, and/or display device) or from an image sensor 532 and/or microphone 570 included in the architecture 500.

When implemented in some user devices, the architecture 500 may also comprise a display component 506. The display component 506 may comprise one or more light-emitting diodes (LEDs) or other suitable display lamps. Also, in some examples, the display component 506 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 506 may be effective to display input images generated in accordance with the various techniques described herein. In various examples, the display component 506 may be a wearable display (e.g., in a headset, goggles, and/or glasses) that may display the various graphical highlight data, graphical navigational hints, text, other graphical data, etc., described herein. In some examples, the architecture 500 may include one or more speakers effective to output audio.

The architecture 500 may also include one or more input devices 508 operable to receive inputs from a user. The input devices 508 can include, for example, a push button, touch pad, touch screen, wheel, joystick, keyboard, mouse, trackball, keypad, light gun, game controller, or any other such device or element whereby a user can provide inputs to the architecture 500. These input devices 508 may be incorporated into the architecture 500 or operably coupled to the architecture 500 via wired or wireless interface. In some examples, architecture 500 may include a microphone 570 or an array of microphones for capturing sounds, such as voice requests. In various examples, audio captured by microphone 570 may be streamed to external computing devices via communication interface 512.

When the display component 506 includes a touch-sensitive display, the input devices 508 can include a touch sensor that operates in conjunction with the display component 506 to permit users to interact with the image displayed by the display component 506 using touch inputs (e.g., with a finger or stylus). The architecture 500 may also include a power supply 514, such as a wired alternating current (AC) converter, a rechargeable battery operable to be recharged through conventional plug-in approaches, or through other approaches such as capacitive or inductive charging.

The communication interface 512 may comprise one or more wired or wireless components operable to communicate with one or more other computing devices. For example, the communication interface 512 may comprise a wireless communication module 536 configured to communicate on a network, according to any suitable wireless protocol, such as IEEE 802.11 or another suitable wireless local area network (WLAN) protocol. A short range interface 534 may be configured to communicate using one or more short range wireless protocols such as, for example, near field communications (NFC), Bluetooth, Bluetooth LE, etc. A mobile interface 540 may be configured to communicate utilizing a cellular or other mobile protocol. A Global Positioning System (GPS) interface 538 may be in communication with one or more earth-orbiting satellites or other suitable position-determining systems to identify a position of the architecture 500. A wired communication module 542 may be configured to communicate according to the USB protocol or any other suitable protocol.

The architecture 500 may also include one or more sensors 530 such as, for example, one or more position sensors, image sensors, and/or motion sensors. An image sensor 532 is shown in FIG. 5. Some examples of the architecture 500 may include multiple image sensors 532. For example, a panoramic camera system may comprise multiple image sensors 532 resulting in multiple images and/or video frames that may be stitched and may be blended to form a seamless panoramic output. An example of an image sensor 532 may be a camera configured to capture color information, image geometry information, and/or ambient light information. In various examples, the image sensor 532 may be effective to capture image and/or video frames that may be used to detect the various objects in the physical environment of the user.

As noted above, multiple devices may be employed in a single system. In such a multi-device system, each of the devices may include different components for performing different aspects of the system's processing. The multiple devices may include overlapping components. The components of the various computing device(s), as described herein, are exemplary, and may be located as a stand-alone device or may be included, in whole or in part, as a component of a larger device or system.

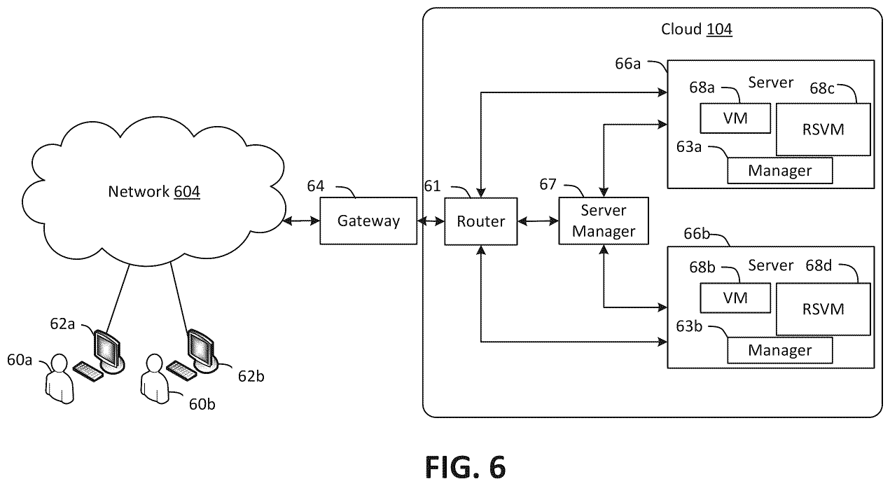

An example system for sending and providing data that may be used to perform one or more of the various techniques described herein will now be described in detail. In particular, FIG. 6 illustrates an example computing environment in which the embodiments described herein may be implemented. For example, the computing environment of FIG. 6 may be an example of a cloud-based environment in which various end node devices (e.g., user computers 62a, 62b, etc.) communicate with a back-end distributed computing network (e.g., cloud 104) through one or more gateway devices (such as gateway 64). FIG. 6 is a diagram schematically illustrating an example of a cloud 104 (e.g., a data center) that can provide computing resources to users 60a and 60b (which may be referred herein singularly as user 60 or in the plural as users 60) via user computers 62a and 62b (which may be referred herein singularly as user computer 62 or in the plural as user computers 62) via a computer communication network 604. Cloud 104 may be configured to provide computing resources for executing applications on a permanent or an as-needed basis. The computing resources provided by cloud 104 may include various types of resources, such as gateway resources, load balancing resources, routing resources, networking resources, computing resources, volatile and non-volatile memory resources, content delivery resources, data processing resources, data storage resources, data communication resources, and the like. Each type of computing resource may be available in a number of specific configurations. For example, data processing resources may be available as virtual machine instances that may be configured to provide various web services. In addition, combinations of resources may be made available via a network and may be configured as one or more web services. The instances may be configured to execute applications, including web services, such as application services, media services, database services, processing services, gateway services, storage services, routing services, security services, encryption services, load balancing services, application services, and the like. In various examples, the instances may be configured to execute one or more of the various image processing techniques described herein.

These services may be configurable with set or custom applications and may be configurable in size, execution, cost, latency, type, duration, accessibility, and in any other dimension. These web services may be configured as available infrastructure for one or more clients and can include one or more applications configured as a platform or as software for one or more clients. These web services may be made available via one or more communications protocols. These communications protocols may include, for example, hypertext transfer protocol (HTTP) or non-HTTP protocols. These communications protocols may also include, for example, more reliable transport layer protocols, such as transmission control protocol (TCP), and less reliable transport layer protocols, such as user datagram protocol (UDP). Data storage resources may include file storage devices, block storage devices, and the like.

Each type or configuration of computing resource may be available in different sizes, such as large resources—consisting of many processors, large amounts of memory and/or large storage capacity—and small resources—consisting of fewer processors, smaller amounts of memory, and/or smaller storage capacity. Customers may choose to allocate a number of small processing resources as web servers and/or one large processing resource as a database server, for example.

Cloud 104 may include servers 66a and 66b (which may be referred herein singularly as server 66 or in the plural as servers 66) that provide computing resources. These resources may be available as bare metal resources or as virtual machine instances 68a-d (which may be referred herein singularly as virtual machine instance 68 or in the plural as virtual machine instances 68). In at least some examples, server manager 67 may control operation of and/or maintain servers 66. Virtual machine instances 68c and 68d are rendition switching virtual machine (“RSVM”) instances. The RSVM virtual machine instances 68c and 68d may be configured to perform all, or any portion, of the techniques for improved rendition switching and/or any other of the disclosed techniques in accordance with the present disclosure and described in detail above. As should be appreciated, while the particular example illustrated in FIG. 6 includes one RSVM virtual machine in each server, this is merely an example. A server may include more than one RSVM virtual machine or may not include any RSVM virtual machines.

The availability of virtualization technologies for computing hardware has afforded benefits for providing large scale computing resources for customers and allowing computing resources to be efficiently and securely shared between multiple customers. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource. Furthermore, some virtualization technologies may provide virtual resources that span one or more physical resources, such as a single virtual machine instance with multiple virtual processors that span multiple distinct physical computing systems.

Referring to FIG. 6, network 604 may, for example, be a publicly accessible network of linked networks and possibly operated by various distinct parties, such as the Internet. In other embodiments, network 604 may be a private network, such as a corporate or university network that is wholly or partially inaccessible to non-privileged users. In still other embodiments, network 604 may include one or more private networks with access to and/or from the Internet.

Network 604 may provide access to user computers 62. User computers 62 may be computers utilized by users 60 or other customers of cloud 104. For instance, user computer 62a or 62b may be a server, a desktop or laptop personal computer, a tablet computer, a wireless telephone, a personal digital assistant (PDA), an e-book reader, a game console, a set-top box, or any other computing device capable of accessing cloud 104. User computer 62a or 62b may connect directly to the Internet (e.g., via a cable modem or a Digital Subscriber Line (DSL)). Although only two user computers 62a and 62b are depicted, it should be appreciated that there may be multiple user computers.

User computers 62 may also be utilized to configure aspects of the computing resources provided by cloud 104. In this regard, cloud 104 might provide a gateway or web interface through which aspects of its operation may be configured through the use of a web browser application program executing on user computer 62. Alternately, a stand-alone application program executing on user computer 62 might access an application programming interface (API) exposed by cloud 104 for performing the configuration operations. Other mechanisms for configuring the operation of various web services available at cloud 104 might also be utilized.

Servers 66 shown in FIG. 6 may be servers configured appropriately for providing the computing resources described above and may provide computing resources for executing one or more web services and/or applications. In one embodiment, the computing resources may be virtual machine instances 68. In the example of virtual machine instances, each of the servers 66 may be configured to execute an instance manager 63a or 63b (which may be referred herein singularly as instance manager 63 or in the plural as instance managers 63) capable of executing the virtual machine instances 68. The instance managers 63 may be a virtual machine monitor (VMM) or another type of program configured to enable the execution of virtual machine instances 68 on server 66, for example. As discussed above, each of the virtual machine instances 68 may be configured to execute all or a portion of an application.

It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example cloud 104 shown in FIG. 6, a router 61 may be utilized to interconnect the servers 66a and 66b. Router 61 may also be connected to gateway 64, which is connected to network 604. Router 61 may be connected to one or more load balancers, and may, alone or in combination, manage communications within networks in cloud 104, for example, by forwarding packets or other data communications as appropriate based on characteristics of such communications (e.g., header information including source and/or destination addresses, protocol identifiers, size, processing requirements, etc.), and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

In the example cloud 104 shown in FIG. 6, a cloud 104 is also employed to at least in part direct various communications to, from and/or between servers 66a and 66b. While FIG. 6 depicts router 61 positioned between gateway 64 and cloud 104, this is merely an exemplary configuration. In some cases, for example, cloud 104 may be positioned between gateway 64 and router 61. Cloud 104 may, in some cases, examine portions of incoming communications from user computers 62 to determine one or more appropriate servers 66 to receive and/or process the incoming communications. Cloud 104 may determine appropriate servers to receive and/or process the incoming communications based on factors such as an identity, location, or other attributes associated with user computers 62, a nature of a task with which the communications are associated, a priority of a task with which the communications are associated, a duration of a task with which the communications are associated, a size and/or estimated resource usage of a task with which the communications are associated, and many other factors. Cloud 104 may, for example, collect or otherwise have access to state information and other information associated with various tasks in order to, for example, assist in managing communications and other operations associated with such tasks.

It should be appreciated that the network topology illustrated in FIG. 6 has been greatly simplified and that many more networks and networking devices may be utilized to interconnect the various computing systems disclosed herein. These network topologies and devices should be apparent to those skilled in the art.

It should also be appreciated that cloud 104 described in FIG. 6 is merely illustrative and that other implementations might be utilized. It should also be appreciated that a server, gateway or other computing device may comprise any combination of hardware or software that can interact and perform the described types of functionality, including without limitation: desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities.

A network set up by an entity, such as a company or a public sector organization, to provide one or more web services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment and the like, configured to implement and distribute the infrastructure, and web services offered by the provider network. The resources may in some embodiments be offered to clients in various units related to the web service, such as an amount of storage capacity for storage, processing capability for processing, as instances, as sets of related services, and the like. A virtual computing instance may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

A number of different types of computing devices may be used singly or in combination to implement the resources of the provider network in different embodiments, for example, computer servers, storage devices, network devices, and the like. In some embodiments, a client or user may be provided direct access to a resource instance, e.g., by giving a user an administrator login and password. In other embodiments, the provider network operator may allow clients to specify execution requirements for specified client applications and schedule execution of the applications on behalf of the client on execution platforms (such as application server instances, Java™ virtual machines (JVMs), general-purpose or special-purpose operating systems, platforms that support various interpreted or compiled programming languages such as Ruby, Perl, Python, C, C++, and the like, or high-performance computing platforms) suitable for the applications, without, for example, requiring the client to access an instance or an execution platform directly. A given execution platform may utilize one or more resource instances in some implementations; in other implementations, multiple execution platforms may be mapped to a single resource instance.

In many environments, operators of provider networks that implement different types of virtualized computing, storage and/or other network-accessible functionality may allow customers to reserve or purchase access to resources in various resource acquisition modes. The computing resource provider may provide facilities for customers to select and launch the desired computing resources, deploy application components to the computing resources and maintain an application executing in the environment. In addition, the computing resource provider may provide further facilities for the customer to quickly and easily scale up or scale down the numbers and types of resources allocated to the application, either manually or through automatic scaling, as demand for or capacity requirements of the application change. The computing resources provided by the computing resource provider may be made available in discrete units, which may be referred to as instances. An instance may represent a physical server hardware platform, a virtual machine instance executing on a server or some combination of the two. Various types and configurations of instances may be made available, including different sizes of resources executing different operating systems (OS) and/or hypervisors, and with various installed software applications, runtimes and the like. Instances may further be available in specific availability zones, representing a logical region, a fault tolerant region, a data center or other geographic location of the underlying computing hardware, for example. Instances may be copied within an availability zone or across availability zones to improve the redundancy of the instance, and instances may be migrated within a particular availability zone or across availability zones. As one example, the latency for client communications with a particular server in an availability zone may be less than the latency for client communications with a different server. As such, an instance may be migrated from the higher latency server to the lower latency server to improve the overall client experience.

In some embodiments, the provider network may be organized into a plurality of geographical regions, and each region may include one or more availability zones. An availability zone (which may also be referred to as an availability container) in turn may comprise one or more distinct locations or data centers, configured in such a way that the resources in a given availability zone may be isolated or insulated from failures in other availability zones. That is, a failure in one availability zone may not be expected to result in a failure in any other availability zone. Thus, the availability profile of a resource instance is intended to be independent of the availability profile of a resource instance in a different availability zone. Clients may be able to protect their applications from failures at a single location by launching multiple application instances in respective availability zones. At the same time, in some implementations inexpensive and low latency network connectivity may be provided between resource instances that reside within the same geographical region (and network transmissions between resources of the same availability zone may be even faster).

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those of ordinary skill in the art and consequently, are not described in detail herein.

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A method comprising
receiving first data from a gateway device;
storing, based on the first data, a first interference value in association with the gateway device;
determining, for a first modulation and coding scheme based on interference data for a gateway device, a first plurality of estimated packet success values that are each associated with a respective value for a signal metric, the interference data including the first interference value;
determining, for a second modulation and coding scheme based on interference data for a gateway device, a second plurality of estimated packet success values that are each associated with a respective value for the signal metric;
receiving second data from the gateway device;
determining, based on the second data, a first value for the first signal metric;
determining, based on the first value for the first signal metric and at least one of the first plurality of estimated packet success values, a first estimated packet success value for the first modulation and coding scheme;
determining, based on the first value for the first signal metric and at least one of the second plurality of estimated packet success values, a second estimated packet success value for the first modulation and coding scheme; and
sending, based on the first estimated packet success value for the first modulation and coding scheme and the second estimated packet success value for the second modulation and coding scheme, third data to the gateway device, the third data indicating to switch from the first modulation and coding scheme to the second modulation and coding scheme.

2. The method of claim 1, wherein the first signal metric comprises a signal to noise ratio, and wherein the method comprises:
determining, based on a first value for the first signal metric, a first bit error rate value for the first modulation and coding scheme;
determining, based on the first bit error rate value for the first modulation and coding scheme, a first symbol error rate value for the first modulation and coding scheme;
determining, based on the interference data, a first interference value;
determining, based on the interference data, a second interference value;
wherein one of the first plurality of estimated packet success values is determined based on the first interference value, the second interference value, and the first symbol error rate value for the first modulation and coding scheme.

3. The method of claim 1, wherein the first data indicates a first signal strength value determined by the gateway device, and wherein the method comprises
determining a thermal noise floor value based on the first signal strength value, a noise figure value associated with the gateway device, and a bandwidth value associated with the gateway device; and
determining the first interference value based on the first signal strength value and the thermal noise floor value.

4. A method comprising determining for a first transmission scheme, based on interference data for a gateway device, a first plurality of estimated packet success values that are each associated with a respective value for a signal metric;
receiving first signal data from the gateway device;
determining, based on the first signal data, a first value for the signal metric;
determining, based on the first value for the first signal metric and at least one of the first plurality of estimated packet success values, a first estimated packet success value for the first transmission scheme;
sending, based on the first estimated packet success value for the first transmission scheme, second data to the gateway device indicating a transmission scheme.

5. The method of claim 4, wherein the method comprises, prior to determining the first plurality of estimated packet success values,
receiving third data from the gateway device; and
storing, based on the third data, a first interference value in association with the gateway device;
wherein the interference data includes the first interference value.

6. The method of claim 5, wherein the third data indicates the first interference value.

7. The method of claim 5, wherein the third data indicates a first signal strength value determined by the gateway device, and wherein the method comprises determining, based on the first signal strength value, the first interference value.

8. The method of claim 5, wherein the third data indicates a first signal strength value determined by the gateway device, and wherein the method comprises
determining, based on the first signal strength value and a noise value associated with the gateway device, the first interference value.

9. The method of claim 5, wherein the third data indicates a first signal strength value determined by the gateway device, and wherein the method comprises
determining a thermal noise floor value based on the first signal strength value, a noise figure value associated with the gateway device, and a bandwidth value associated with the gateway device; and
determining the first interference value based on the first signal strength value and the thermal noise floor value.

10. The method of claim 4, wherein the method further comprises storing each respective packet success value of the first plurality of estimated packet success values in association with
the corresponding respective value for the signal metric, and
the first transmission scheme.

11. The method of claim 4, wherein the determining of the first estimated packet success value is based on determining that the first value for the signal metric matches the respective value associated with one of the estimated packet success values of the plurality of estimated packet success values.

12. The method of claim 4, wherein the method further comprises
determining that the first value for the signal metric is
greater than a first respective value for the signal metric associated with a second estimated packet success value of the first plurality of estimated packet success values, and
less than a second respective value for the signal metric associated with a third estimated packet success value of the first plurality of estimated packet success values;
wherein the first estimated packet success value is determined based on
the first respective value for the signal metric associated with the second estimated packet success value of the first plurality of estimated packet success values,
the second respective value for the signal metric associated with the third estimated packet success value of the first plurality of estimated packet success values,
the second estimated packet success value of the first plurality of estimated packet success values,
the third estimated packet success value of the first plurality of estimated packet success values, and
the first value for the signal metric.

13. The method of claim 4, wherein the method comprises:
determining, based on a first value for the signal metric, a first bit error rate value for the first transmission scheme;
determining, based on the first bit error rate value for the first transmission scheme, a first symbol error rate value for the first transmission scheme;
determining, based on the interference data, a first interference value;
determining, based on the interference data, a second interference value;
wherein one of the first plurality of estimated packet success values is determined based on the first interference value, the second interference value, and the first symbol error rate value for the first transmission scheme.

14. The method of claim 4, wherein the method comprises:
determining, based on a first value for the signal metric, a first bit error rate value for the first transmission scheme;
determining, based on the first bit error rate value for the first transmission scheme, a first symbol error rate value for the first transmission scheme;
determining, based on the interference data, a first set of interference values, a number of interference values in the first set corresponding to a number of symbols in a packet for the first transmission scheme;
wherein one of the first plurality of estimated packet success values is determined based on the first set of interference values and the first symbol error rate value for the first transmission scheme.

15. The method of claim 4, wherein the method comprises:
determining, based on a first value for the signal metric, a first bit error rate value for the first transmission scheme;
determining, based on the first bit error rate value for the first transmission scheme, a first symbol error rate value for the first transmission scheme;
determining, based on the interference data, a first interference value;
determining, based on the interference data, a second interference value;
determining, based on the first interference value, the second interference value, and the first symbol error rate value for the first transmission scheme, a second estimated packet success value;
determining, based on the interference data, a third interference value;
determining, based on the interference data, a fourth interference value; and
determining, based on the third interference value, the fourth interference value, and the first symbol error rate value for the first transmission scheme, a third estimated packet success value;
wherein the first estimated packet success value is determined based on the second estimated packet success value and the third estimated packet success value.

16. The method of claim 4, wherein the method comprises:
determining, based on a first value for the signal metric, a first bit error rate value for the first transmission scheme;
determining, based on the first bit error rate value for the first transmission scheme, a first symbol error rate value for the first transmission scheme;
determining, based on the interference data, a first set of interference values, a number of interference values in the first set corresponding to a number of symbols in a packet for the first transmission scheme;
determining, based on the interference data, a second set of interference values, a number of interference values in the second set corresponding to the number of symbols in a packet for the first transmission scheme;
wherein one of the first plurality of estimated packet success values is determined based on the first interference value, the second interference value, and the first symbol error rate value for the first transmission scheme.

17. The method of claim 4, wherein the method comprises:
determining, based on a first value for the signal metric, a first bit error rate value for the first transmission scheme;
determining, based on the first bit error rate value for the first transmission scheme, a first symbol error rate value for the first transmission scheme;
determining, based on the interference data, a first set of interference values, a number of interference values in the first set corresponding to a number of symbols in a packet for the first transmission scheme;
determining, based on the first set of interference values and the first symbol error rate value for the first transmission scheme, a second estimated packet success value;
determining, based on the interference data, a second set of interference values, a number of interference values in the second set corresponding to the number of symbols in a packet for the first transmission scheme;
determining, based on the second set of interference values and the first symbol error rate value for the first transmission scheme, a third estimated packet success value;
wherein one of the first plurality of estimated packet success values is determined based on the second estimated packet success value and the third estimated packet success value.

18. The method of claim 17, wherein the first estimated packet success value is an estimated packet error rate, the second estimated packet success value is an estimated packet success rate, and the third estimated packet success value is an estimated packet success rate.

19. The method of claim 4, wherein the signal metric is a signal to noise ratio.

20. The method of claim 4, wherein the signal metric is a received signal strength.

21. The method of claim 4, wherein the first estimated packet success value is an estimated packet error rate.

22. The method of claim 4, wherein the first estimated packet success value is an estimated packet success rate.

23. The method of claim 4, wherein the first data indicates a first signal strength value determined by the gateway device.

24. The method of claim 4, wherein the first data indicates a first signal to noise ratio value determined by the gateway device.

25. The method of claim 24, wherein the first data indicates the first value for the signal metric.

26. The method of claim 4, wherein the second data indicates the first transmission scheme.

27. The method of claim 4, wherein the second data indicates a second transmission scheme.

28. The method of claim 4, wherein the method comprises:
determining, for a second transmission scheme based on the interference data for the gateway device, a second plurality of estimated packet success values that are each associated with a respective value for a signal metric;
determining, based on the first value for the signal metric and at least one of the second plurality of estimated packet success values, a second estimated packet success value for the second transmission scheme; and
wherein the second data is determined based on the second estimated packet success value for the second transmission scheme.

29. The method of claim 4, wherein the method comprises determining a power consumption value for the first transmission scheme.

30. The method of claim 4, wherein the method comprises:
determining, for a second transmission scheme based on the interference data for the gateway device, a second plurality of estimated packet success values that are each associated with a respective value for a signal metric;
determining, based on the first value for the signal metric and at least one of the second plurality of estimated packet success values, a second estimated packet success value for the second transmission scheme;
determining a first power consumption value for the first transmission scheme; and
determining a second power consumption value for the second transmission scheme;
wherein the second data is determined based on the second estimated packet success value for the second transmission scheme, the first power consumption value, and the second power consumption value.

31. An electronic device comprising:
a wireless transceiver;
one or more processors;
one or more computer readable media storing computer executable instructions that, when executed by one or more processors of the electronic device, cause the electronic device to perform operations comprising
determining, at a first time, a first received signal strength value,
determining, based on the first received signal strength value, a first interference value,
sending, to a remote computing system, the first interference value,
determining, at a second time, a second received signal strength value,
sending, to the remote computing system, first data based on the second received signal strength value, and
receiving, from the remote computing system, second data determined based on the first interference value and the first data, the second data indicating a first transmission scheme.

32. The electronic device of claim 31, wherein the first data indicates the second received signal strength value.

33. The electronic device of claim 31, wherein the one or more computer readable media store computer executable instructions that, when executed by one or more processors of the electronic device, cause the electronic device to perform operations comprising
determining, based on the second received signal strength value, a signal to noise ratio value, and wherein the first data indicates the signal to noise ratio value.

34. The electronic device of claim 31, wherein the one or more computer readable media store computer executable instructions that, when executed by one or more processors of the electronic device, cause the electronic device to perform operations comprising
determining a thermal noise floor value based on the first signal strength value, a noise figure value associated with the electronic device, and a bandwidth value;
wherein the first interference value is determined based on the first signal strength value and the thermal noise floor value.

35. The electronic device of claim 31, wherein the one or more computer readable media store computer executable instructions that, when executed by one or more processors of the electronic device, cause the electronic device to perform operations comprising, based on the receiving of the second data indicating the first transmission scheme, sending third data to another electronic device using the first transmission scheme.

36. The electronic device of claim 31, wherein the one or more computer readable media store computer executable instructions that, when executed by one or more processors of the electronic device, cause the electronic device to perform operations comprising, based on the receiving of the second data indicating the first transmission scheme, sending third data to another electronic device indicating to use the first transmission scheme.

37. The electronic device of claim 31, wherein the first transmission scheme is a first modulation and coding scheme.

38. The method of claim 4, wherein the first transmission scheme is a first modulation and coding scheme.
